(19) United States
(12) Patent Application Publication
(10) Pub. No.: US 2013/0125538 A1
(43) Pub. Date: May 23, 2013

(54) Torque Transmission Device With Electrical Insulation

(71) Applicants: Peter Frey, (US); Michael Heuler, (US); Georg Mencher, (US)

(72) Inventors: Peter Frey, (US); Michael Heuler, (US); Georg Mencher, (US)

(73) Assignee: ZF Friedrichshafen AG, Friedrichshafen (DE)

(21) Appl. No.: 13/670,695

(22) Filed: Nov. 7, 2012

(30) Foreign Application Priority Data
Nov. 8, 2011 (DE) 10 2011 085 884.9

(51) Int. Cl. F16C 33/02; F16C 33/30

(52) U.S. Cl. CPC F16C 33/02; F16C 33/30
USPC 60/330; 384/91; 384/127

(57) ABSTRACT

A torque transmission device, particularly for a motor vehicle, for the transmission of a torque from a driving unit, particularly from an internal combustion engine, to a driven unit, particularly a transmission, has at least one bearing location which has at least one bearing support acting in axial and/or radial direction, wherein an insulation element preventing a flow of electric current is provided in the region of the at least one bearing location.

### BACKGROUND OF THE INVENTION

1. Field of the Invention

The present invention is directed to a torque transmission device, particularly for a motor vehicle, for the transmission of a torque from a driving unit, particularly from an internal combustion engine, to a driven unit, particularly a transmission, having at least one bearing location which has at least one bearing support acting in axial and/or radial direction.

2. Description of the Related Art

A torque transmission device of the type mentioned above can be, for example, a clutch arrangement, a dual-mass flywheel or a torque converter. Torque transmission devices of this kind are commonly arranged in the drivetrain of a vehicle between a driving unit, i.e., the engine, and a driven unit, i.e., the transmission. However, in modern drivetrains it has been shown that while most of the current can still be diverted to the body via a ground cable during the process of starting the vehicle by means of a starter, the remaining residual amount of current can be transmitted to the transmission proceeding from the starter via various structural component parts of the drivetrain. The current introduced into the transmission in this way can result in damage to transmission components and impaired operation. For example, it can lead to fusing of movable parts due to the heating action of the current.

The prior art DE 37 21 705 A1 discloses a torsional vibration damper which has electrical insulation in the region of the spring elements to prevent the springs from fusing to the housing during a welding process for welding the housing of the torsion damper. For this purpose, particularly the spring pockets and/or the stops of the springs can be made of an insulating material. Further, the prior art discloses that the torsion damper has in the region of the springs a coating which insulates in a stable manner at least over the duration of the welding process.

However, it is a drawback of this prior art that the electrical insulating effect, particularly in the case of the coating, is designed merely for the welding process. During continuous introduction of current via the starter and the movement of the springs at the coating, the coating can be damaged and only provides an insufficient current insulation. Also, forming the spring pockets as plastic element provides only an insufficient electrical insulation because precisely during high mechanical stresses, plastic elements at the spring seats do not withstand the mechanical stresses. Moreover, it has been shown that arranging plastic elements in the spring pockets impedes the assembly of the torsion damper and adds significantly to cost because of the additional time.

Therefore, it is an object of the present invention to provide a torque transmission device which provides an electrical insulation between the internal combustion engine and the transmission and which is implemented in an economical and simple manner.

### SUMMARY OF THE INVENTION

According to the invention, a torque transmission device is provided for transmitting a torque from a driving unit to a driven unit, wherein the torque transmission device further has at least one bearing location having at least one bearing support acting in axial and/or radial direction. The invention is based on the idea of providing an insulation element in the region of the at least one bearing location so as to prevent the flow of electric current, and the insulation element according to the invention can be constructed directly as an element of the bearing or as an element that is added on to the bearing. In view of the fact that current is commonly introduced preferably at the bearing locations, this transfer of current is prevented particularly effectively in that, according to the invention, the insulation element is arranged in the region of the bearing locations.

The insulation element can be combined with any bearing locations, for example, compact bearings, plain bearings or roller bearings.

According to a preferred embodiment, the insulation element is made from an electrically insulating material, particularly plastic or ceramic. Apart from good insulating properties, ceramic also has the advantage that it withstands high mechanical loads. Plastic, on the other hand, is advantageous because it can deform easily.

According to a further preferred embodiment, the insulation element has a coating of an electrically insulating material or is formed as a coating. In this respect, a coating of ceramic, particularly a ceramic layer based on silicon oxide, chromium and/or chromium nitride and/or a layer based on a preferably amorphous carbon structure and/or a coat of lacquer have proven particularly advantageous. The embodiment as coating has the advantage that there is no need for additional elements.

Further, a combination, for example, in the form of an aluminum disk with an anodic layer, is also possible.

According to a further advantageous embodiment, the insulation element has at least one axially oriented insulation element portion and/or at least one radially oriented insulation element portion. This has the advantage that the insulation element can be arranged at the axial bearing locations and/or at the radial bearing locations.

It is particularly advantageous when the at least one insulation element is formed as a radially and/or axially extending ring element which can be used as an integral element for a bearing.

The insulation element can be formed as an axially extending ring element, particularly as ring disk, or as a radially extending ring element, preferably as sleeve.

This has the particular advantage that the insulation element can be arranged directly as a plain bearing on the torque transmission device.

According to a further advantageous embodiment, the insulation element can have an element for securing against rotation and/or an element for preventing misassembly. This ensures that during installation, particularly at the bearing location, the insulation element does not restrict movement of the elements or increase the installation space. Further, it has the advantage that elements can be provided for securing the structural component parts axially and radially at the same time.

According to another advantageous embodiment, the insulation element is designed to cooperate with a bearing element of a plain bearing and/or of a roller bearing and/or to be embodied as bearing element for a plain bearing and/or roller bearing. The insulation element can advantageously be constructed as bearing seat for a plain bearing and/or roller bearing, particularly for a thrust bearing.

This has the advantage that the separately fabricated bearing seat is not exposed to strong mechanical stresses so that it is possible to construct the bearing seat as plastic element and, therefore, as insulation element.

According to a further advantageous embodiment, the insulation element can have a bearing washer and/or a thrust washer for a roller bearing, particularly for a needle bearing, preferably for a needle thrust bearing and/or can be constructed as a bearing washer and/or thrust washer for a roller bearing.

This has the advantage that elements of the bearing support embody or receive the insulation element integrally so that assembly is simplified.

In an advantageous manner, the insulation element can have at least one locking projection in which an element of the bearing, particularly of the roller bearing, can be locked. Of course, an embodiment in which the insulation element locks into a locking projection formed at the roller bearing is also possible.

The insulation element with locking projection can preferably be further developed in such a way that at least two locking projections are provided, these locking projections being at the same time so disposed as to provide elements for securing against rotation or elements for preventing misassembly. It is particularly advantageous when the locking projections have an asymmetrical angular distribution circumferentially. For example, the locking projections can be arranged so as to be offset relative to one another, e.g., at 210° and 150° rather than at 180° so that a preferred installation orientation is formed.

To facilitate assembly of the individual structural component parts in an optimized manner with respect to time, a plurality of elements can advantageously be assembled in assembly units, e.g., as insulation element with locking projections and bearing washer, as insulation element with thrust washer, or as a combination of the two. Further, the locking projection acts as retention element, i.e., it prevents axial and/or radial displacement of the structural component parts relative to one another and/or relative to the thrust washer.

According to a further advantageous embodiment, the insulation element is constructed as a rolling element for a roller bearing, particularly as a ball for a ball bearing. In order to withstand mechanical loads, it can be advantageous that the insulation element is constructed as a ceramic element.

Generally, embodying the insulation element as an element of a bearing support has the advantage that the bearing with integrated insulation element can be provided as a finished assembly unit so that a fast and simple assembly is ensured.

According to a further advantageous embodiment, the torque transmission device can be a wet or dry starting element, particularly a torque converter, and/or a clutch arrangement and/or a dual-mass flywheel and/or a torsion damper.

The insulation of a torque converter with at least an impeller, a stator and/or a turbine is particularly advantageous, wherein the impeller has an impeller shell which can be connected to a driving unit so as to be fixed with respect to rotation relative to it, and the turbine has a turbine shell which can be connected to a driven unit so as to be fixed with respect to rotation relative to it. The stator is preferably arranged on a freewheel which is supported by at least one thrust washer and/or at least one thrust bearing at the impeller shell and/or turbine shell. The at least one insulation element is preferably arranged in the region of the stator.

According to a further advantageous embodiment, the insulation element is further designed to cooperate with at least one thrust washer arranged at the stator and/or is formed integral with at least one thrust washer arranged at the stator. The arrangement of the insulation element at the stator, particularly at the thrust washer, advantageously allows a particularly good electrical insulation and a simple assembly.

According to another advantageous embodiment, the insulation element is arranged between a thrust washer and a bearing washer of the thrust bearing support. Optional advantageous elements for preventing misassembly and/or elements for securing against rotation can be formed so as to act in direction of the thrust washer and in direction of the bearing washer.

Alternatively or in addition, the insulation element can also be formed as an element of the freewheel, preferably as an inner ring of the freewheel or as an outer ring of the freewheel.

According to a further advantageous embodiment, the insulation element can be arranged between the impeller shell and the thrust bearing support on the impeller shell side, particularly as a needle thrust bearing seat and/or as a needle thrust bearing support.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The illustrated embodiments are purely exemplary and do not affect the scope of the invention, which is defined solely by the appended claims. The invention will be described more fully in the following with reference to the drawings in which:

FIG. 1 is a schematic sectional view through a torque converter according to the invention;

FIG. 2 is a schematic diagram of a first preferred embodiment for an insulation element according to the invention in the torque converter according to the invention shown in FIG. 1;

FIG. 3 is an enlarged view of the embodiment according to the invention shown in FIG. 2;

FIG. 4A is an enlarged view of the insulation element according to the invention in an assembled state ;

FIG. 4B is an exploded view of the insulation element of FIG. 4A;

FIG. 5 is a schematic diagram of another detail of the insulation element according to the invention for use in a torque converter according to FIGS. 1 and 2;

FIG. 6 is a schematic diagram of another detail of the insulation element according to the invention for use in a torque converter according to FIGS. 1 and 2;

FIG. 7 is a schematic diagram of a second preferred embodiment for an insulation element according to the invention in the torque converter according to the invention shown in FIG. 1;

FIG. 8 is a schematic diagram of a third preferred embodiment for an insulation element according to the invention in the torque converter according to the invention shown in FIG. 1;

FIG. 9 is a schematic diagram of a fourth preferred embodiment for an insulation element according to the invention in the torque converter according to the invention shown in FIG. 1;

FIG. 10 is a schematic diagram of a fifth preferred embodiment for an insulation element according to the invention in the torque converter according to the invention shown in FIG. 1;

FIG. 11 is a schematic diagram of a sixth preferred embodiment for an insulation element according to the invention in the torque converter according to the invention shown in FIG. 1;

FIG. 12 is a schematic diagram of a seventh preferred embodiment for an insulation element according to the invention in the torque converter according to the invention shown in FIG. 1;

FIG. 13 is a schematic sectional view of a dual clutch device according to the invention having an insulation element according to the invention;

FIG. 14 is a schematic sectional view through a clutch device for incorporating an electric machine having insulation element according to the invention;

FIG. 15 is a schematic sectional view through a hydrodynamically cooled clutch device having an insulation element according to the invention; and

FIG. 16 is a schematic sectional view through a hydrodynamically cooled vibration damper having an insulation element according to the invention.

### DETAILED DESCRIPTION OF THE PRESENTLY PREFERRED EMBODIMENTS

In the following similar elements or similarly functioning elements are designated by the same reference numerals.

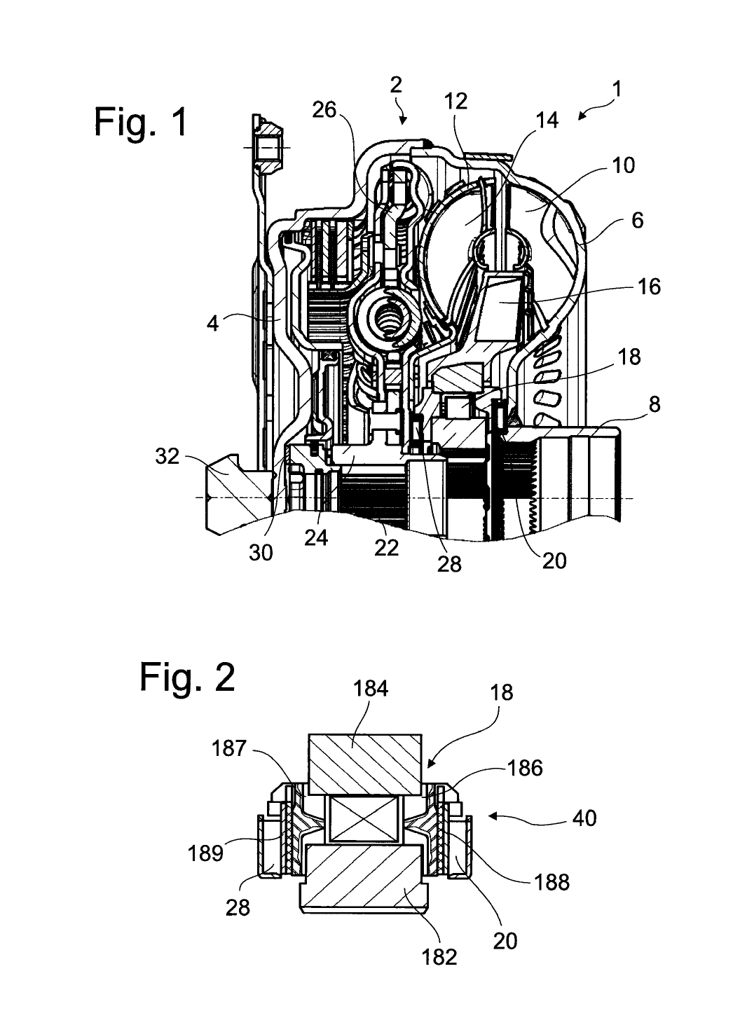

FIG. 1 shows a wet clutch arrangement 1 in the form of a hydrodynamic torque converter. The housing 2 has at its side facing a drive (not shown) a housing cover 4 which is fixedly connected to an impeller shell 6. This impeller shell 6 merges with an impeller hub 8 in the radially inner region.

The impeller shell 6 together with impeller blades forms an impeller 10 which cooperates with a turbine 14 having a turbine shell 12 with turbine blades and with a stator 16 having stator blades. Impeller 10, turbine 14 and stator 16 form a hydrodynamic circuit in a known manner.

The stator 16 is arranged on a freewheel 18 which is supported axially at the impeller hub 8 by a thrust bearing support 20. The impeller hub 8 is hollow and receives a transmission input shaft 22 within its interior.

By means of toothing, the transmission input shaft 22 receives a torsion damper hub 24 of a torsional vibration damper 26 so as to be fixed with respect to rotation but axially displaceable relative to it. The torsion damper hub 24 is supported at the freewheel 18, already mentioned, by a thrust bearing support 28.

Further, the transmission input shaft 22 can be supported at the drive-side end thereof at the drive-side housing cover 4 of the torque converter 1 by a plain bearing 30. As can be gathered from the arrangement of the structural component parts of the illustrated torque converter 1, a current can be transmitted during the starting process from a drive, for example via a driven shaft 32, to the drive-side housing cover 4 of the torque converter 1. From the latter location, the current can be introduced to the transmission input shaft 22 directly via bearing location 30. Further, current can be introduced to the transmission input shaft 22 via the housing 2, impeller shell 6, thrust bearing 20, freewheel 18, thrust bearing 28, and torsion damper hub 24.

To prevent the flow of current from the drive via housing 2 and impeller shell 6 into transmission input shaft 22 and onward into the transmission, the torque converter 1 has at least one insulation element according to the invention. According to the invention, the bearing locations of thrust bearings 20 and 28, respectively, in the region of the stator 16 and the bearing 30 at the drive-side end of the transmission input shaft 22 are particularly suitable for the arrangement of the insulation element or insulation elements.

FIGS. 2 to 11 show in detail different embodiments for an electrical insulation by means of the at least one insulation element, according to the invention, for the torque converter 1, particularly in the region of the stator 16. In this regard, there may be one or more possibilities individually or in combination.

FIG. 2 shows an enlarged view of the freewheel 18 carrying the stator 16. As can be seen from the enlarged view in FIG. 2, the freewheel 18 has an inner ring 182, an outer ring 184 and thrust washers 186 and 187 arranged axially at both sides thereof. The thrust bearing 20 and 28, respectively, is arranged axially adjacent to the thrust washers 186, 187; two bearing washers 188 and 189 are provided, respectively, between thrust bearings 20, 28 and the associated thrust washers 186, 187.

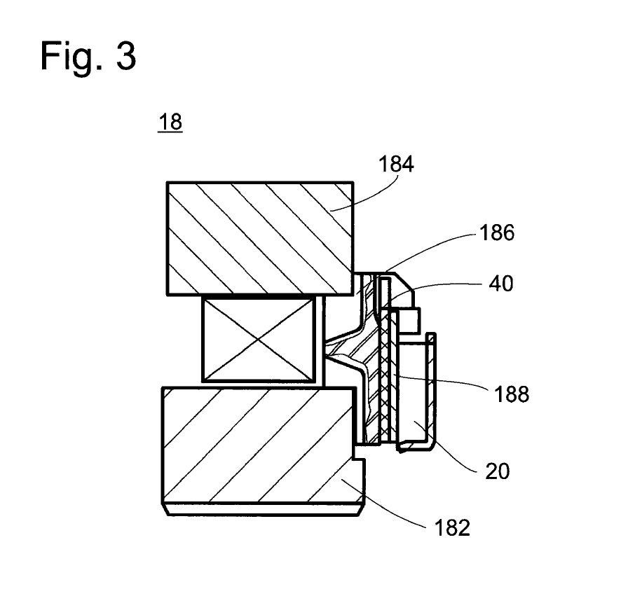

According to the invention, there is provided at least on one side between thrust bearing 20 and thrust bearing 28 an insulation element 40 which is arranged between thrust washer 186 and 187, respectively, and bearing washers or rings 188 and 189, respectively. FIG. 3 shows the construction in an enlarged view for better understanding.

To prevent wear of the insulation element 40, particularly when it is formed as a plastic disk, the thrust washer 186 and/or the plastic disk 40 itself can have one or more elements for securing against rotation to prevent relative movement between thrust washer 186 and plastic disk 40.

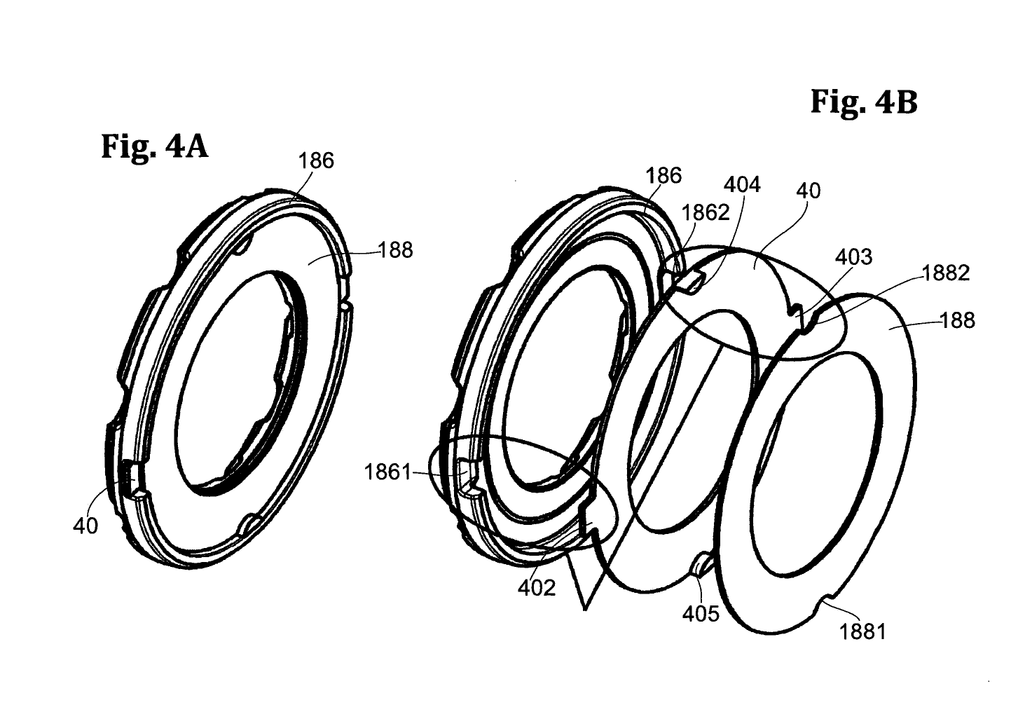

FIG. 4 shows the construction according to the invention comprising thrust washer 186, insulation element, here plastic disk 40 arranged integral with the latter, and bearing washer or ring 188 in assembled state (FIG. 4a) and in an exploded view (FIG. 4b). As can be seen from the exploded view in FIG. 4b, one or more elements for securing against rotation and one or more elements for preventing misassembly can be further provided and are realized at the plastic element 40 in the illustrated embodiment. To this end, the plastic element 40 has projections 402, 403 and 404, 405. Projections 402, 403 are designed to engage in indentations 1861, 1862 at the thrust washer 186, while projections 404 are designed to engage in indentations 1881, 1882 at the bearing ring 188. This ensures that the insulation element 40 is arranged so as to be fixed with respect to rotation relative to the thrust washer 186 and bearing ring 188 so as to minimize wear of the insulation element.

To prevent faulty installation, the projections 402, 403 and 404, 405, respectively, can further have an asymmetrical angular distribution so that it is ensured that projections 402, 403 cooperate with thrust washer 186 and projections 404, 405 cooperate with bearing ring 188.

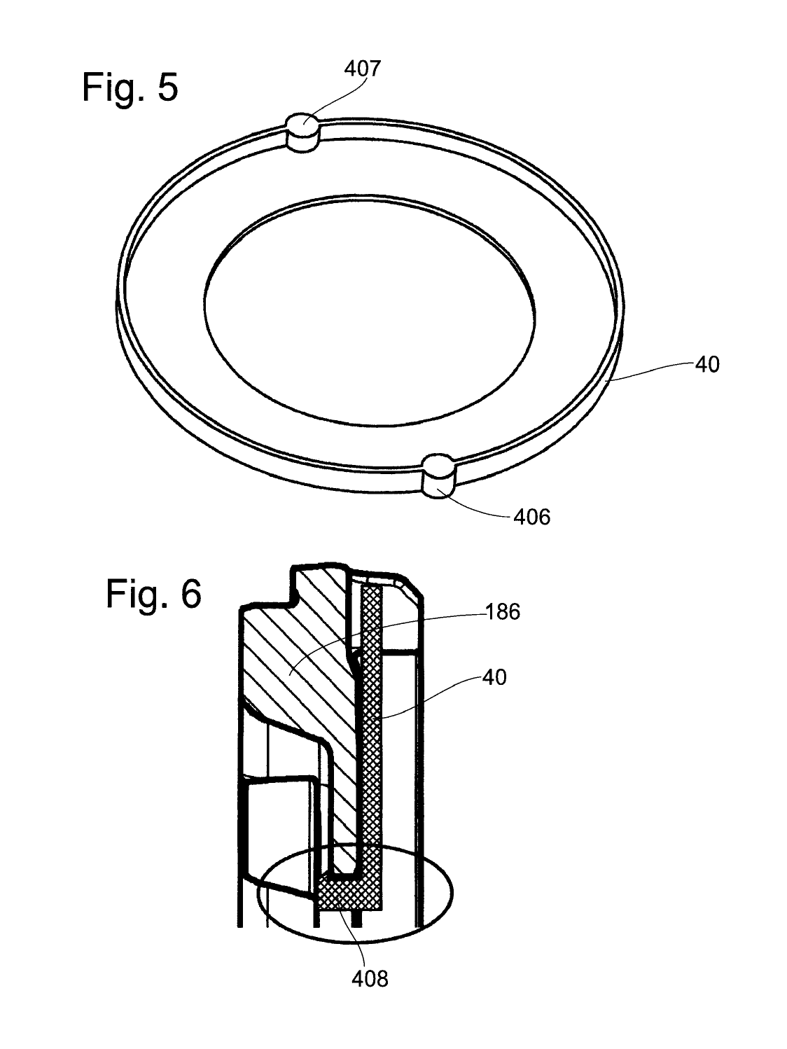

FIG. 5 shows another preferred embodiment of the insulation element according to the invention in which the projections 406, 407 act as elements for securing against rotation and also perform an axial centering function.

Further, as is shown in FIG. 6, the insulation element 40 can have projections 408 which are formed as locking projections and which cooperate with the thrust washer 186 in such a way that insulation element 40 and thrust washer 186 form an assembly unit. This makes it possible to provide the thrust washer 186 and insulation element 40 as an assembly unit, which in turn facilitates and speeds up assembly of the entire torque converter 1. Of course, the locking projection 408 can also be formed at the thrust washer. Alternatively or additionally, the bearing ring 188 can also be combined by means of locking projections with the insulation element 40 and possibly the thrust washer 186 to form an assembly unit.

The embodiment with locking projections 408 has the further advantage that the locking projections 408 serve as retention elements and prevent axial and/or radial displacement of the structural component parts relative to one another.

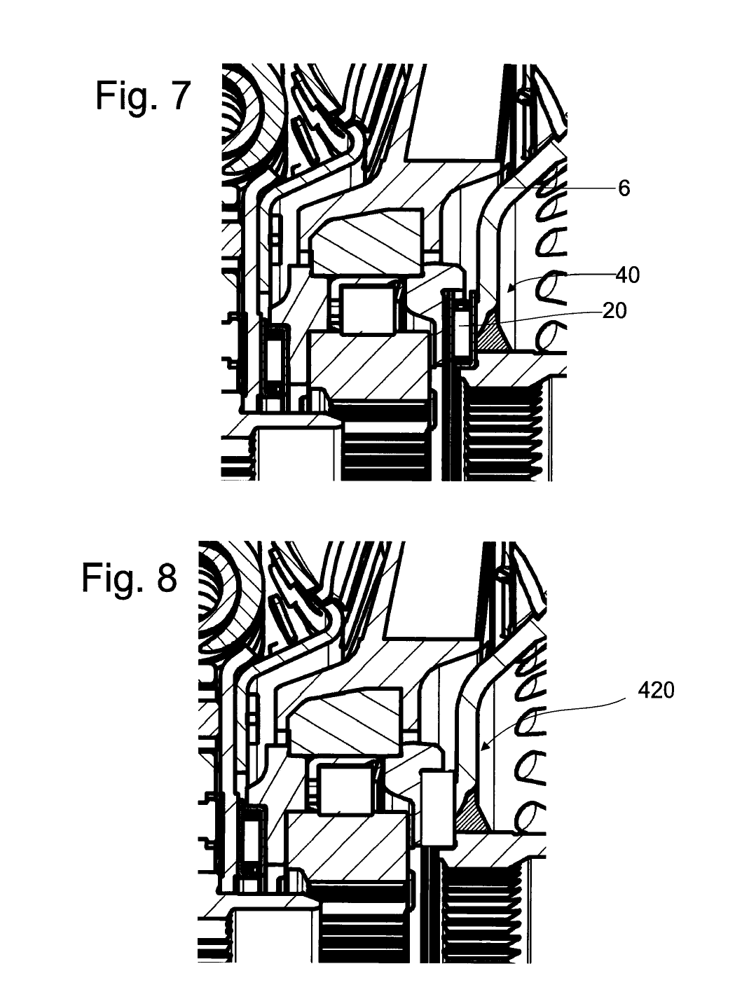

FIG. 7 shows another preferred embodiment for the arrangement of an electrical insulation element in a torque converter 1. As can be seen from FIG. 7, insulation against current is accomplished in this instance between the impeller shell 6 and the bearing 20. This can be effected by means of a current-insulating disk or, as is shown in FIG. 7, in that the electrical insulation element 40 is arranged as a bearing seat between the needle thrust bearing 20 and the impeller shell 6. The electrical insulation element preferably extends over the entire axial length and radially over the entire radial length of the needle thrust bearing 20. Also in the electrical insulation element 40 shown in FIG. 7, the radial extensions can be formed as an element constructed to prevent misassembly or to secure against rotation as was described above.

Instead of outfitting the needle thrust bearing 20 with a current-insulating element 40, a current insulation element which simultaneously functions as bearing 420, for example, a plain bearing of current-insulating material, can also be used as is shown by the embodiment in FIG. 8.

In a manner analogous to the embodiments shown in FIGS. 2 to 8, the thrust bearing 28 can also be constructed so as to insulate against current between freewheel 18 and torsion damper 26.

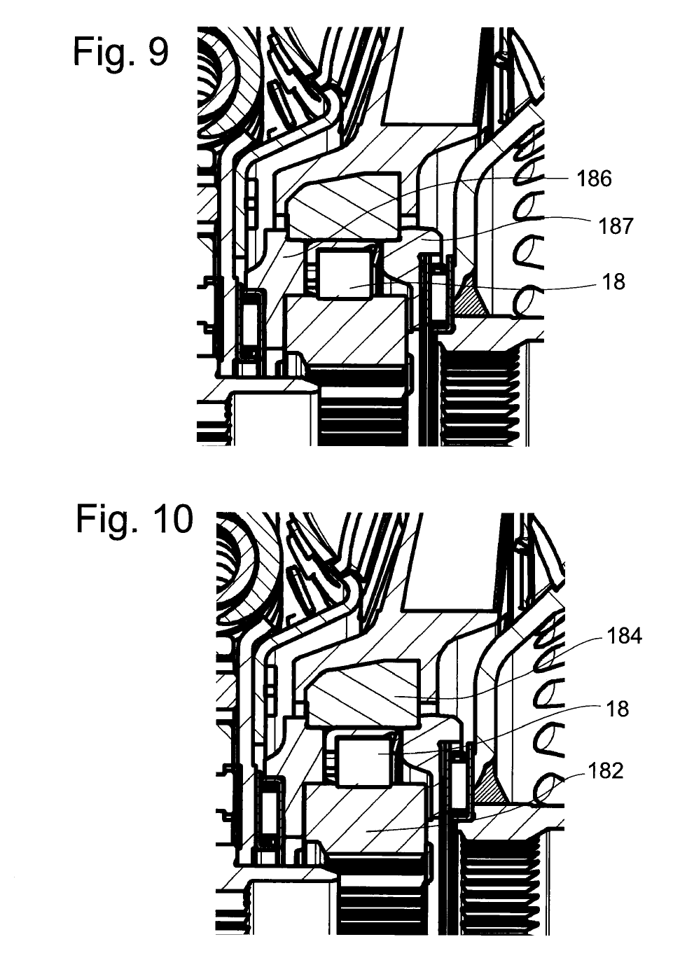

However, not only can the elements or the thrust bearing 20 and 28, respectively, themselves be used as current insulation location, but the thrust washers 186, 187 of the stator 16 can also be fabricated from a current-insulating material as is shown by the embodiment illustrated in FIG. 9. Alternatively or additionally, the inner freewheel ring 182 and/or outer freewheel ring 184 of the stator 16 can also be fabricated from current-insulating material. An embodiment of this kind is illustrated in FIG. 10. Of course, in the embodiments shown in FIGS. 9 and 10, only one of the elements, for example, only the transmission-side thrust washer 186 and/or, for example, the inner freewheel ring 182, can comprise current-insulating material.

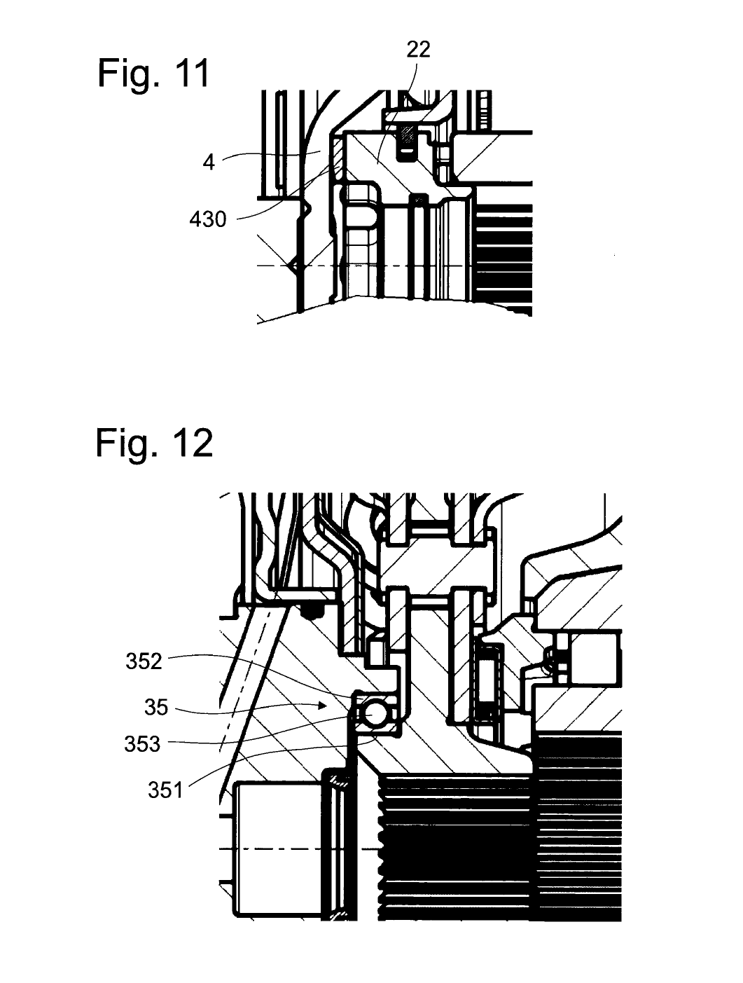

In addition to or instead of the arrangement of the current-insulating element at the thrust bearing locations 20, 28 of the stator 16, it is also conceivable to arrange a current-insulating plain bearing 430 on the drive side between the housing cover 4 and the drive-side end of the transmission input shaft 22. FIG. 11 shows a corresponding embodiment in which a plain bearing 430 formed as current-insulating element is arranged between the torque converter housing cover 4 and the drive-side end of the transmission input shaft 22. This plain bearing 430 can be realized, for example, by a plastic ring.

Of course, a ball bearing 35 can also have the current-insulating element 40 according to the invention or can be constructed in an insulating manner. To this end, for example, as is shown in FIG. 12, the inner ring 351 and/or the outer ring 352 and/or the insulated rolling elements 353 can also be fabricated from a current-insulating material, particularly ceramic. Ceramic has the advantage over plastic that its running properties, frictional properties and wear properties are more advantageous compared to plastic.

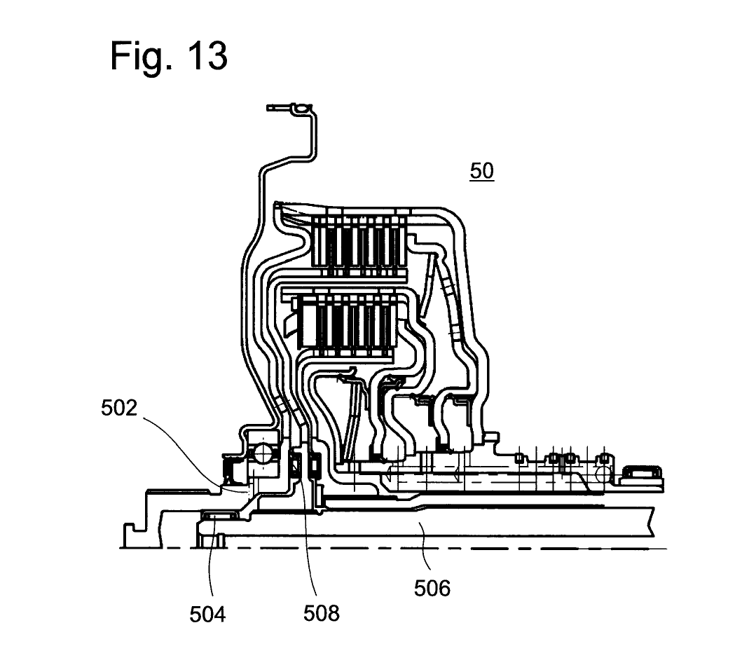

In addition to the embodiments for a torque converter 1 which have already been shown, other torque transmission devices can also be outfitted with a current-insulating element 40 according to the invention. FIGS. 13 to 16 schematically show different torque transmission devices in which the bearing locations at which the at least one insulation element 40 according to the invention is preferably arranged are marked. Reference is made to FIGS. 2 to 12 for possible embodiments of the insulation element 40. The embodiments are also applicable in an analogous manner for other torque transmission devices.

FIG. 13 shows a schematic diagram of a wet dual clutch 50 which functions in a manner known from the prior art. The drive-side clutch input 502 of the dual clutch 50 shown in FIG. 13 is radially supported by a radial bearing 504 at the transmission input shaft 506. At the same time, the drive-side driver member 502 is axially supported relative to the driven side by thrust bearing 508. Both bearing locations 504, 508 are particularly suitable for the arrangement of an electrical insulation element. An electrical insulation element 40 of the type described above can be used.

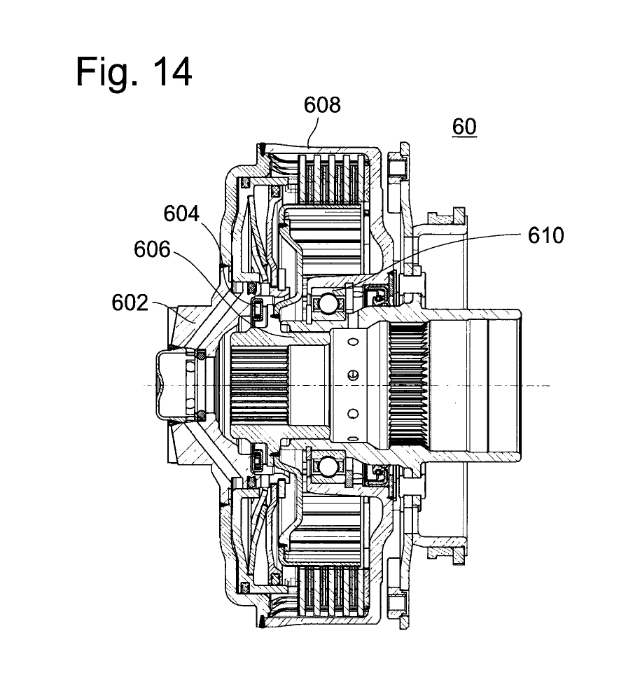

FIG. 14 shows a clutch mechanism 60 for incorporating an electric machine. As in FIG. 13, current can also be introduced in this instance via a drive-side clutch input element 602 which can transmit the current to the transmission input shaft 606 directly via bearing location 604. Further, the current can be conducted to the transmission input shaft 606 via housing 608 and the bearing location formed as ball bearing 610. According to the invention, one or more of the bearing locations 604, 610 can be outfitted with an insulation element 40, described above, in order to prevent current from entering the transmission.

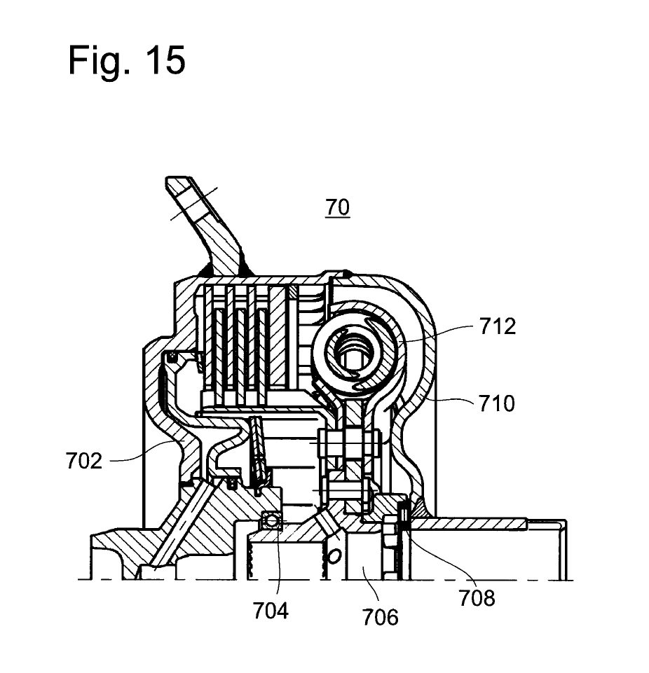

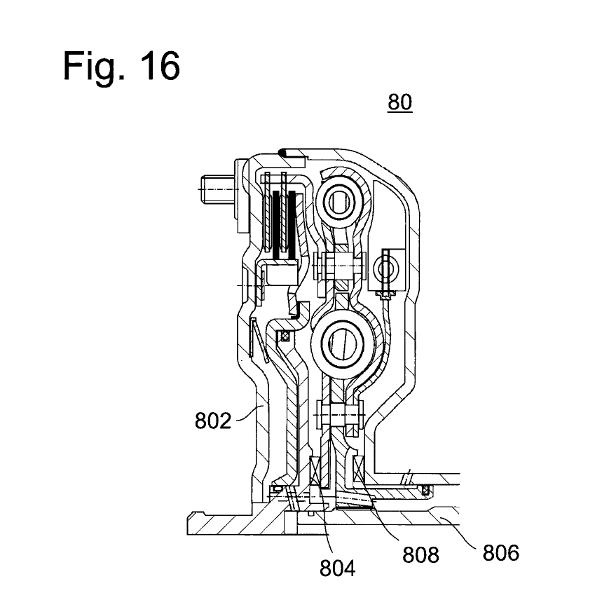

FIG. 15 shows another torque transmission device, namely a hydrodynamically cooled clutch 70, in a schematic sectional view. As was already described with reference to the other drawings, it is advantageous to arrange the current-insulating element 40 at the bearing locations at which a drive-side housing element 702 is supported at the driven-side transmission input shaft 706 or at structural component parts which can be connected to the transmission input shaft 706. In the hydrodynamically cooled clutch 70 shown in FIG. 16, preferred bearing locations are the ball bearing 704 which supports the drive-side housing cover 702 relative to the transmission input shaft 706 and the needle thrust bearing 708 which supports the driven-side housing cover 710 relative to the transmission input shaft 706 and the vibration damper 712. An insulation element 40 as described above is also advantageously arranged in these regions in order to prevent the entry of current from the engine to the transmission during the starting process.

FIG. 16 shows a hydrodynamically cooled vibration damping element which is likewise designed to transmit torque. The axial bearing locations 804 and 808 for receiving an electrical insulation element are also especially suited in the present embodiment to prevent the entry of current from the drive-side input element 802 to the transmission input shaft 806.

Since current insulation takes place from drive side to driven side at the bearing locations of the torque transmission devices, a simple assembly is possible on the one hand and a permanent current insulation is possible on the other hand.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A torque transmission device, particularly for a motor vehicle, for the transmission of a torque from a driving unit, particularly from an internal combustion engine, to a driven unit, particularly a transmission, comprising:
at least one bearing location including at least one bearing support acting in one of an axial and radial direction; and
an insulation element preventing a flow of electric current disposed in the region of said at least one bearing location.

2. The torque transmission device according to claim 1, wherein said at least one insulation element is made from an electrically insulating material.

3. The torque transmission device according to claim 1, wherein said at least one insulation element comprises a coating of electrically insulating material.

4. The torque transmission device according to claim 3, wherein said coating comprises a ceramic layer.

5. The torque transmission device according to claim 1, wherein said at least one insulation element comprises one of at least one axially oriented insulation element portion and at least one radially oriented insulation element portion.

6. The torque transmission device according to claim 1, wherein said at least one insulation element is formed as one of a radially and axially extending ring element.

7. The torque transmission device according to claim 5, wherein said axial insulation element portion is formed as an axially extending ring element.

8. The torque transmission device according to one of claim 5, wherein said radially oriented insulation element portion is formed as radially extending ring element.

9. The torque transmission device according to claim 1, wherein said at least one insulation element comprises an element constructed to secure said at least one insulation element against one of rotation and to prevent misassembly.

10. The torque transmission device according to claim 5, wherein said radially oriented insulation element portion comprises an element constructed to secure said radially oriented insulation element portion against one of rotation and to prevent misassembly.

11. The torque transmission device according to claim 1, additionally comprising at least one of a roller bearing and a plain bearing having a bearing element and wherein said at least one insulation element is designed so as to one of cooperate with one of said bearing element of said plain bearing and said roller bearing and be embodied as one of said bearing element for said plain bearing and said roller bearing.

12. The torque transmission device according to claim 11, wherein said at least one insulation element is constructed as a bearing seat for one of said plain bearing and said roller bearing.

13. The torque transmission device according to claim 11, wherein said at least one insulation element comprises one of a bearing washer and a thrust washer for said roller bearing.

14. The torque transmission device according to claim 13, wherein said at least one insulation element comprises at least one locking projection for receiving one of said bearing washer and said thrust washer.

15. The torque transmission device according to claim 14, wherein said at least one insulation element comprises at least two locking projections constructed and arranged so as to prevent misassembly.

16. The torque transmission device according to claim 11, wherein said at least one insulation element is constructed as a rolling element for said roller bearing.

17. The torque transmission device according to claim 1, wherein said torque transmission device is one of a wet and dry starting element.

18. The torque transmission device according to claim 1, wherein said torque transmission device is a torque converter comprising a free wheel; at least an impeller; and one of a stator and a turbine; said impeller comprising an impeller shell connectable to a driving unit so as to be fixed with respect to rotation relative thereto; said turbine comprising a turbine shell connectable to a driven unit so as to be fixed with respect to rotation relative thereto; said stator being arranged on said freewheel which is supported by one of at least one thrust washer and at least one thrust bearing support at one of said impeller shell and said turbine shell; and said at least one insulation element being arranged in the region of said stator.

19. The torque transmission device according to claim 18, wherein said at least one insulation element is constructed to one of cooperate with said at least one thrust washer arranged at said stator and so as formed integral with said at least one thrust washer arranged at said stator.

20. The torque transmission device according to claim 18, wherein said thrust bearing support additionally comprises a bearing washer and said at least one insulation element is arranged between said at least one thrust washer and said bearing washer of said thrust bearing support.

21. The torque transmission device according to claim 18, wherein said at least one insulation element is formed as an element of said freewheel.

22. The torque transmission device according to claim 18, wherein said at least one insulation element is arranged between said impeller shell and said thrust bearing support on the impeller shell side.

23. The torque transmission device according to claim 2, wherein said electrically insulating material is one of plastic and ceramic.

24. The torque transmission device according to claim 3, wherein said coating of electrically insulating material is based on one of silicone oxide, chromium, chromium nitride, carbon structure and lacquer.

25. The torque transmission device according to claim 5, wherein said axial insulation element portion is formed as a ring disk.

26. The torque transmission device according to claim 6, wherein said axial insulation element portion is formed as an axially extending ring element.

27. The torque transmission device according to claim 6, wherein said axial insulation element portion is formed as a ring disk.

28. The torque transmission device according to claim 8, wherein said radially oriented insulation element portion is formed as a radially extending sleeve.

29. The torque transmission device according to claim 15, wherein said at least two locking projections comprise an asymmetrical angular distribution.

30. The torque transmission device according to claim 16, wherein said rolling element is a ball for a ball bearing.

31. The torque transmission device according to claim 17, wherein one of said wet and dry starting elements is one of a torque converter, clutch arrangement, dualmass fly wheel and a torsional vibration damper.

32. The torque transmission device according to claim 21, wherein said at least one insulation element is formed as one of an inner ring of said freewheel and an outer ring of said freewheel.

33. The torque transmission device according to claim 22, wherein said at least one insulation element is constructed as one of a needle thrust bearing and as a thrust bearing support.
